(19) United States
(12) Patent Application Publication
(10) Pub. No.: US 2006/0059172 A1
(43) Pub. Date: Mar. 16, 2006

(54) Method and system for developing data life cycle policies

(75) Inventor: Murthy V. Devarakonda, Peekskill, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/938,032

(22) Filed: Sep. 10, 2004

(51) Int. Cl. G06F 7/00

(52) U.S. Cl. 707/100

(57) ABSTRACT

Data life cycle policies are developed by classifying data into data classes based upon predetermined data attributes. States are then specified in which the data classes may reside. Components are defined that support one or more of the states. Transfer agents support transferring data from one component to another component. A state transition diagram is prepared for each data class, including one or more conditions that are necessary for each transition between states. An algorithm is applied to the state transition diagram which generates policies that generate life cycle actions if the data or file belongs to the class, the present state of the data or file, and if the conditions for the transitions between the states for each data class have been met. The algorithm provides a method and system for developing data life cycle policies.

### FIELD OF THE INVENTION

The present invention relates to resource management in computer systems. Specifically, the invention relates to on-demand computing, highly responsive systems, autonomic computing, policy refinement, and policy-based management. More specifically, the invention relates to a method and system for developing data life cycle policies.

### BACKGROUND OF THE INVENTION

Computer users face many issues today as they build or grow their storage infrastructures. Although the cost of purchasing storage hardware continues its rapid decline, the cost of managing storage is not keeping pace. In some cases, storage management costs are actually rising. The purchase price of storage hardware comprises as little as five or ten percent of the total cost of storage. Factors such as administration costs, downtime, environmental overhead, device management tasks, and backup and recovery procedures make up the majority of the total cost of ownership. Information technology managers are under significant pressure to reduce costs while deploying more storage to remain competitive. They must address the increasing complexity of storage systems, the explosive growth in data, and the shortage of skilled storage administrators.

Furthermore, the storage infrastructure must be designed to help maximize the availability of critical applications.

In today's on-demand environment, data is a critical asset for an enterprise. Data life cycle management determines how data is stored, backed up, archived, replicated, and finally deleted or retained permanently based on business objectives, including conformance to legal requirements. Since data in an enterprise is growing exponentially, manual data life cycle management is intractable. Enterprises are beginning to use policy-based systems to automate data life cycle management. In such systems, policies specify where to store new data when it is created, when and how it should be backed up, archived, replicated, and when and how it should be deleted or retained permanently. Often, different stages of the life cycle are implemented by different products thus requiring different policies for different products. Designing valid, effective, and consistent data life cycle policies across many products is a difficult problem because of the huge quantity of data being managed as well as the significant variability in the way different kinds of data should be managed. At the present time, there are no systematic methods for developing these policies, so administrators can only rely on the rule of thumb and past practices as a guide to designing and tuning data life cycle policies.

SAN File System (SFS) placement policies are known to those skilled in the art. IBM SAN File System, also known as, Storage Tank™ is a Storage Area Network (SAN) based distributed file system and storage management solution that enables shared heterogeneous file access, centralized management, and enterprise-wide scalability. Similar file systems are available from other vendors. The IBM system is described in “IBM Storage Tank—A heterogeneous scalable SAN file system” by J. Menon et al, IBM Systems Journal, vol. 42, no. 2, 2003, pp 250-267.

IBM Tivoli™ Storage Manager is a client/server application that provides backup and recovery operations, archival and retrieval operations, hierarchical storage management, and disaster recovery planning across client hosts. Similar tools are available from other vendors. The IBM Tivoli Storage Manager (TSM) is described in the article entitled “Beyond backup toward storage management” by M. Kaczmarski et al, IBM Systems Journal, vol. 42, no. 2, 2003, pp 322-337.

Currently existing efforts in the field of policy-based computing as applied to networking are described in “Policy-Based Networking: Architecture and Algorithms”, by D. C. Verma, New Riders Publishing, 2001.

All of these publications are hereby incorporated herein by reference.

### SUMMARY OF THE INVENTION

A method and system for a systematic development of data life cycle policies includes classifying data, creating a state transition diagram for each data class for various stages of its life cycle, and then using the storage system architecture to develop policies for data life cycle management. Policies are developed by applying graph algorithms on a state transition diagram. Today no such comprehensive tool and methodology exists, as a result administrators do not know if the policies they have developed and put in place are effective and consistent.

An aspect of the preferred embodiments of this invention is the provision of tools for facilitating the development of data life cycle policies.

Another aspect of the preferred embodiments of this invention is the provision of tools for developing comprehensive data life cycle states and transitions between them, and then using the resulting states and transitions for automatically generating data life cycle management policies which are consistent and meet an overall objective.

A further aspect of the preferred embodiments of this invention is the provision of a method and system to verify and refine data life cycle management policies after they have been developed and are in use in an enterprise.

Further and still other aspects of the preferred embodiments of this invention will become more clearly apparent when the following description is read in conjunction with the accompanying drawings.

### BRIEF DESCRIPTION OF THE FIGURES

FIG. 1 is a schematic block diagram of a system for classifying data.

FIG. 2 is an example of a state transition diagram for one data class.

FIG. 3 shows a preferred embodiment of a storage system architecture according to the teachings of the present invention.

FIG. 4 is chart of a typical identifier of file state attributes.

FIG. 5 is an algorithm for developing data life cycle policies.

### DETAILED DESCRIPTION OF THE INVENTION

In accordance with the preferred embodiments of this invention, data is classified using certain intrinsic attributes or characteristics of the data such as the whole or a part of its file name, size, age, identification of the owner or group, file set it belongs to, client name or any other attribute or characteristic that can be derived from the data contents or its usage. According to the prior art in Menon et al, file set is a subtree of the global namespace.

In accordance with the teachings of the present invention, one or more copies or versions of a data or a data file exist, and each copy or version is always in one particular state, where a state is a collection of management attributes including the name of the storage pool in which the data or file is stored and further information such as whether it is online, offline, in long term retention, has been deleted, is immutable, a backup copy, an archive copy, and/or a replicated copy. In the subsequent description when the term data or file is used, it is understood that the term may refer to a copy of the data or file as implied by the context.

For each class of files, data administrators create a state transition diagram that describes how files belonging to that particular class change their state. The description includes the source state, a destination state, and a condition upon which a transition from the source state to the destination state occurs. For the purposes of the state-transition diagram, a nascent state is assumed which is the state of an unborn file and this nascent state is common to all data classes.

The data life cycle management system comprises several components or tools that are capable of supporting one or more of the states. When a file copy is in a particular state the corresponding tool or component is expected to maintain that state for it and provide access to the file copy as appropriate. For example, SAN FS (Storage Area Network File System) might provide support for two online states for a file copy using two SFS storage pools, and TSM (Tivoli™ Storage Manager) might provide support for an offline backup state using a TSM tape pool. When a file copy is in the two online states its state is maintained by SFS, and when a file copy is in a back state its state is maintained by TSM. Furthermore, the invention assumes a transfer agent between such systems if the state-transition requires moving the file copy or its management from one system to another.

A typical computer system in its most basic form comprises I/O devices for inputting data or instructions and outputting results or data; storage means for storing applications, instructions or databases and the like; and a CPU for performing the instructions according to a program. The present invention is concerned with developing data life cycle policies for the handling of data and files by the storage element of a computer.

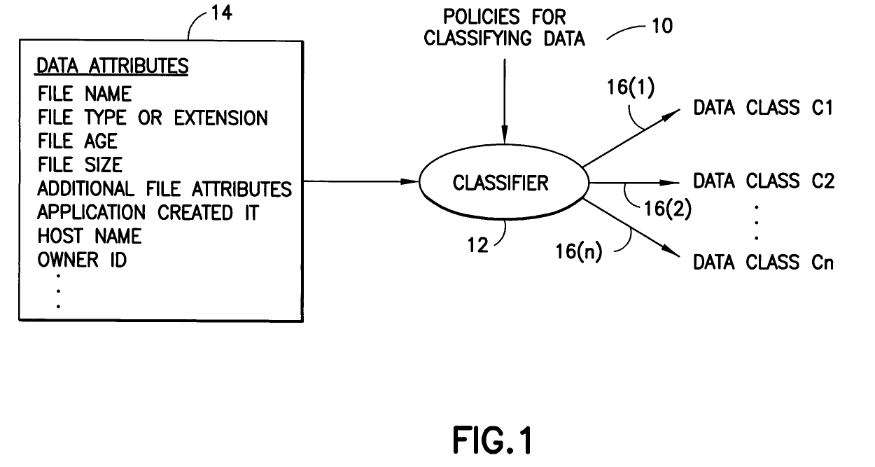

Referring now to the figures and to FIG. 1 in particular, there is shown a schematic block diagram of a system for classifying data. Policies for classifying data 10 is inputted for classification to classifier 12 where data is checked for data attributes or characteristics 14 including, but not limited to, filename, file type or extension, file age, file size, additional file attributes, application used to create data, host name, owner id, or any other attribute or characteristic derivable from the data content or usage. Based upon the policies for classifying data 10 and the attributes of the data 14, the data is classified into data classes, e.g., data class C1, 16(1), data class C2, 16(2), . . . , data class Cn, 16(n). As described below, the different data classes determine the life cycle policy for the respective data.

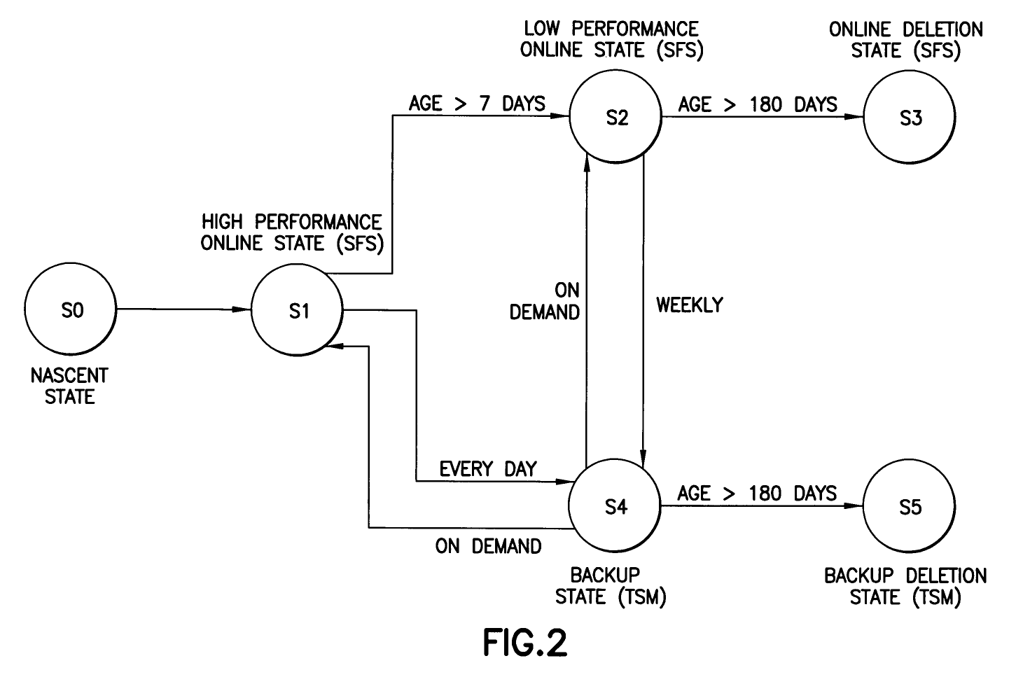

FIG. 2 shows an example of a state transition diagram for a data class. A human administrator creates a state transition diagram for each data class using the user interface and software provided for this purpose. A state transition diagram shows how the state of data changes when the condition for transition is present. The data is initially in a nascent state S0. The data transitions to a high performance online state (SFS) S1 when it is created. When the data in state s1 reaches a predetermined age, i.e. 7 days, there is a state transition from state S1 to a low performance online state (SFS) S2. When data in state S2 reaches a longer predetermined time, i.e 180 days, there is a state transition of the data from state S2 to an on-line deletion state (SFS) S3, which prescribes deletion of data from on-line storage. The data in state S1 undergoes a state transition from state S1 to a backup state (TSM) S4 everyday at a predetermined time such as 12 midnight. This transition creates a copy of the file rather than move the file. The data in state S2 undergoes a state transition from state S2 to backup state (TSM) S4 every week on a predetermined day and time such as Sunday at 12 midnight. This transition also creates a copy of the file rather than move it. On demand, data in state (TSM) S4 is returned to state S1 or S2, depending on its age since creation. This transition also creates a copy of the file. After a long predetermined period of time, i.e. greater than 180 days, the data in state (TSM) S4 undergoes transition to backup deletion state (TSM) S5, where it, i.e. all copies of the file, will be deleted from the backup medium. In this example, data or files are stored, backed up, or deleted based on the age of the data or file, where the age is defined as the time since initial creation. Other criteria, such as age defined as the time since last modification and frequency of usage, may be used as conditions for data to transition form one state to another state. It is also understood that some state transitions move the data whereas the others merely create a copy of the data. For example, when state transition from S2 to S4 occurs, a copy of the data is created in Backup state on TSM while leaving the primary copy in the low performance online state in SFS.

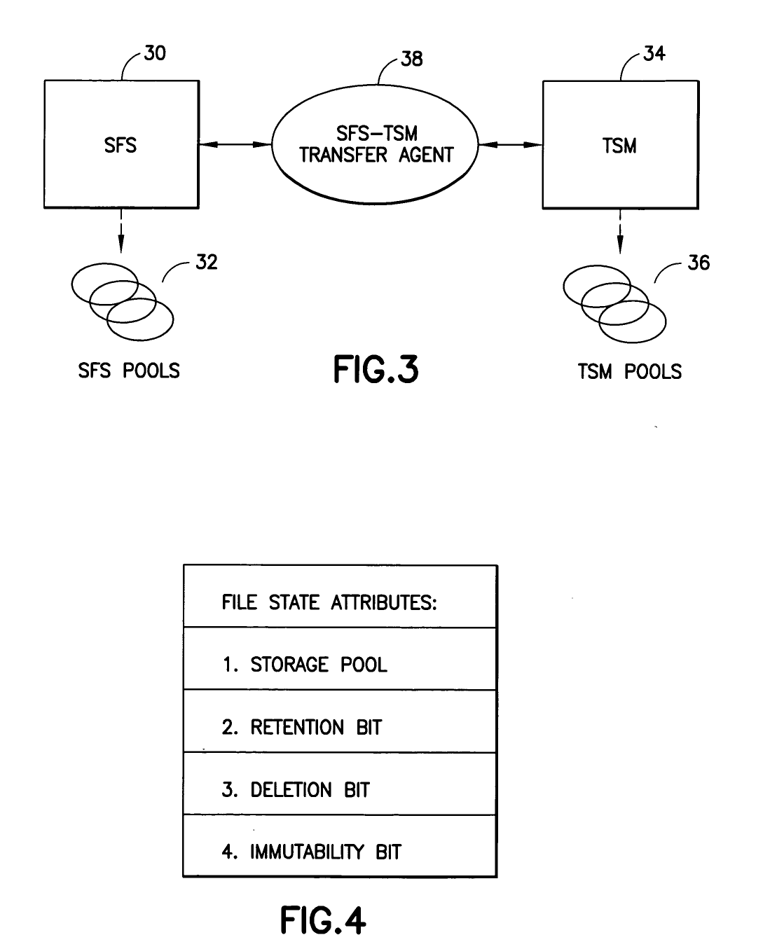

FIG. 3 shows a preferred embodiment of a storage system for transferring data from a storage file system (SFS) 30 containing SFS online storage pools 32 to a Tivoli Storage Manager (TSM) 34 containing TSM offline tape pools 36, and vice versa, via a SFS-TSM transfer agent 38.

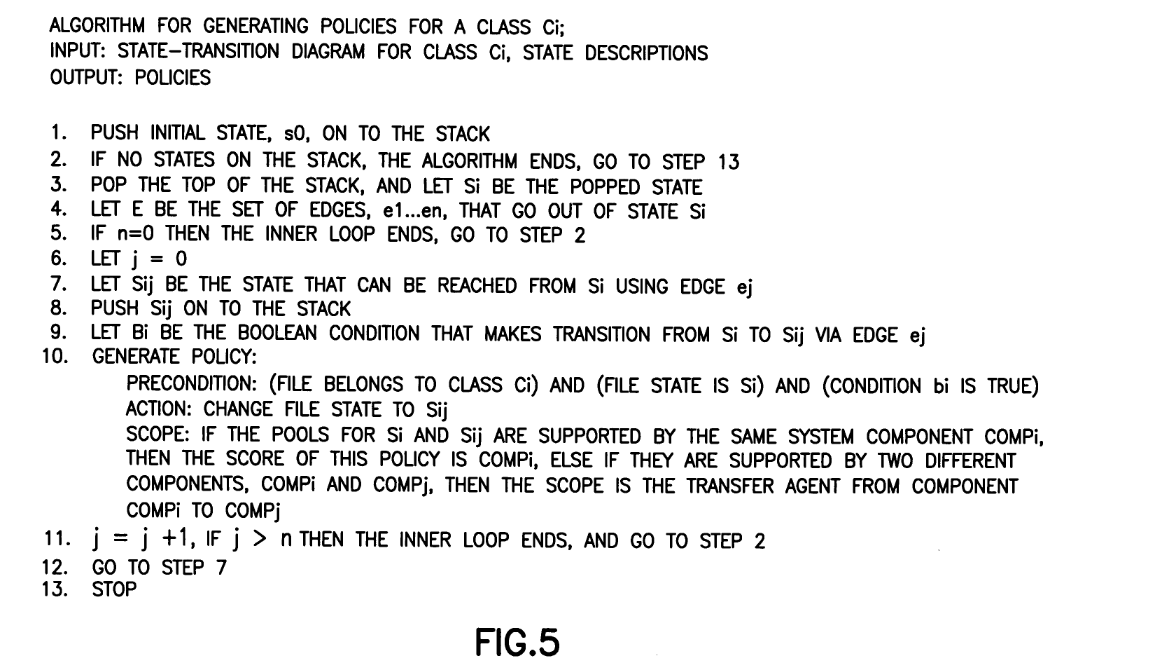

The present invention applies a classic depth-first graph traversal algorithm to derive policies from the state transition diagram. The details of the algorithm are shown in FIG. 5. The algorithm derives a policy for each state transition, where the precondition of the policy includes tests to see if a file belongs to a class, the file's present state, and if the transition condition has been met. The action part of the policy affects the state transition. Changing the state of a file is not usually limited to setting new values for data management attributes. In fact, changing the state usually involves moving the contents of the file from one storage pool to another, creating a backup copy or a replica, and/or such similar resource intensive operations (see FIG. 2). The management attributes will be set appropriately after the necessary management actions have taken place. The scope of the policy will be the system that supports both the source and destination states. If the two states are supported by two different systems then the transfer agent is also within the scope of the policy.

The SFS 30 accesses SFS storage pools 32 of classified data or files in the states S1, S2 or S3 of the transition diagram shown in FIG. 2. The storage pools may be sorted, for example, by storage device type or sorted by attributes. The TSM 34 accesses TSM tape pools 36 of classified data or files in states S4 or S5 of the transition diagram of FIG. 2. The SFS-TSM transfer agent 38 facilitates the transfer of data residing in a SFS pool to a TSM pool and vice versa. For example, data in backup state TSM S4 can be recalled on-demand to state S2 via the SFS-TSM transfer agent 38.

The file state (S0, . . . , S5) may be identified using attributes associated with a copy of a data file, and this state is enforced by one or more system components that perform storage management functions. FIG. 4 shows attributes that associate a state with the data file copy. These attributes identify the storage pool in which file data is stored as well as a retention bit (e.g. for S4), deletion bit (e.g. for S3 or S5), and an immutability bit. It should be noted that the storage and tape pools are abstractions supported in IBM SFS and TSM, and in these systems they are a collection of LUNs (also known as virtual disks) and tapes respectively. When this invention is used with other storage systems, a similar concept may apply.

State transitions, as exemplified in FIG. 3, cause changes in the file state attributes. For example, when a state transition from S1 to S2 occurs for a file, the storage pool attribute of the file changes from a high-performance online SFS storage pool to a low performance online SFS storage pool. As mentioned earlier, some transitions create a copy of a file in a different state. For example, when a state transition from S2 to S4 occurs on a weekly basis, a copy of the file is created in the backup state on TSM. Such a transition causes creation of a new state attribute record for the same file corresponding to the state S4. Therefore, there are more than one state attribute records for a single file, each corresponding to a copy of the file.

FIG. 5 shows an algorithm for generating data life cycle policies for a data class Cᵢ. The input for the algorithm is the state-transition diagram for class Cᵢ and state descriptions. The outputs of the algorithm are the data life cycle policies. A depth-first graph transversal algorithm is the preferred algorithm type, although other algorithms may be used.

The algorithm shown in FIG. 5 performs in the following manner. Push initial state S₀ on to the stack. The state at the top of stack is removed and assigned to the variable Sᵢ. E is the set of edges e₁, . . . , eₙ (n>=0) that go out from the state Sᵢ in the transition diagram. The value of j is initially set to 1. If j>n then this loop ends and another top of the stack state is removed and it is assigned as the new value for Sᵢ and the loop repeats by setting j to 1 again. If there are no states on the stack, the algorithm ends. If j<=n and Sᵢⱼ is the state that can be reached from Sᵢ using edge eⱼ. Sᵢⱼ is pushed on to the stack. Let Bᵢ is the Boolean condition that makes the transition from Sᵢ to Sᵢⱼ via edge eⱼ.

Next, the following policy is generated:
Precondition: (file belongs to class Cᵢ) and (file state is Sᵢ) and (condition Bᵢ is true).
Action: change file state to Sᵢⱼ.
Scope: If the pools Sᵢ and Sᵢⱼ are supported by the same system component COMPᵢ, then the scope of this policy is COMPᵢ. Otherwise, if the pools Sᵢ and Sᵢⱼ are supported by two different components, COMPᵢ and COMPⱼ, then the scope is the transfer agent from component COMPᵢ to component COMPⱼ.

Next, the value of j is incremented by one, but if j>n now the loop ends and a new state, if any, from the top of the stack is removed and assigned to Sᵢ and the loop repeats by setting j to an initial value of 1. If j is not greater than n, then another Sᵢⱼ, which is the state that can be reached from Sᵢ using another edge eⱼ, is pushed on to the stack. After all of the states, all of the edges and all of the conditions are checked, the algorithm ends and the policies for the class Cᵢ is developed. The algorithm is applied then to the next state transition diagram for the next class Cᵢ until all the classes are completed.

Based on the foregoing description it may be appreciated that an aspect of this invention relates to a signal bearing medium that tangibly embodies a program of machine-readable instructions executable by a digital processing apparatus to perform operations to develop a data life cycle policy. The operations include: (a) classifying data according to predetermined attributes; (b) specifying states in which classified data may reside; (c) specifying respective component systems that support different one or more associated states; (d) generating a state transition diagram for each data class where at least one condition is associated with each transition between states; and (e) applying an algorithm for traversing the state transition diagram for developing a data life cycle policy for each data class.

While there has been described and illustrated preferred embodiments of a method and system for developing data life cycle policies and modifications and variations thereof, it will be apparent to those skilled in the art that further variations and modifications are possible without deviating from the broad principles and spirit of the present invention which shall be limited solely by the scope of the claims appended hereto.

What is claimed is:

1. A method to develop data life cycle policies comprising:
classifying data according to predetermined attributes;
specifying states in which classified data may reside;
specifying respective components that support different one or more associated states;
generating a state transition diagram for each data class where at least one condition is associated with each transition between states; and
traversing the state transition diagram for developing a data life cycle policy for each data class.

2. A method to develop data life cycle policies as set forth in claim 1, wherein said generating a state transition diagram for each class generates a state for different stages of data life.

3. A method to develop data life cycle policies as set forth in claim 1, wherein the states of the state transition diagram are related to at lest one of allocation options, caching options, performance priority and availability rights.

4. A method to develop data life cycle policies as set forth in claim 1, wherein the states include a collection of management attributes including a name of a storage pool in which the data or file is stored.

5. A method to develop data life cycle policies as set forth in claim 1, wherein the states include at least one of online data, offline data, long-term data retention, deleted data, immutable data, backup copy, archive copy and replicated copy.

6. A method to develop data life cycle policies as set forth in claim 1, wherein the state transition diagram includes at least one source state, at least one destination state, and at least one condition for data transition from a source state to a destination state.

7. A method to develop data life cycle policies as set forth in claim 6, wherein the transition from a source state to a destination state includes moving data from a first storage pool to another storage pool.

8. A method to develop data life cycle policies as set forth in claim 6, wherein the transition from a source state to a destination state includes moving data from a storage pool to a backup state.

9. A method to develop data life cycle policies as set forth in claim 6, wherein the data life cycle policy comprises a component that supports the source state and the destination state.

10. A method to develop data life cycle policies as set forth in claim 9, wherein the data life cycle policy comprises a plurality of components that support the source state and the destination state.

11. A method to develop data life cycle policies as set forth in claim 6, wherein the life cycle policy comprises a plurality of components and a transfer agent for facilitating transition of data between at least some of the plurality of components.

12. A method to develop data life cycle policies as set forth in claim 6, further comprising a transfer agent for facilitating transition of data between components.

13. A method to develop data life cycle policies as set forth in claim 1, wherein traversing the state transition diagram tests whether the data belongs to a predetermined data class, the data is in a source state and a condition for transition to a destination state is met.

14. A method to develop data life cycle policies as set forth in claim 13, wherein the transition from a source state to a destination state includes moving data from a storage pool to another storage pool.

15. A method to develop data life cycle policies as set forth in claim 13, wherein the transition from a source state to a destination state includes moving data from a storage pool to a backup state.

16. A method to develop data life cycle policies as set forth in claim 1, wherein the predetermined attributes are related to data content.

17. A method to develop data life cycle policies as set forth in claim 1, wherein the predetermined attributes are related to data usage.

18. A method to develop data life cycle policies as set forth in claim 1, wherein the attributes comprise at least some of whole file name, partial file name, file type, file size, file age, application used to create data, identification of owner, identification of group, file set to which file belongs and client name.

19. A system for developing data life cycle policies comprising:
a classifier for classifying data according to predetermined attributes;
means for specifying states in which classified data may reside;
means for specifying respective components that support different one or more associated states;
means for generating a state transition diagram for each data class where at least one condition is associated with each transition between states; and
means for traversing the state transition diagram for
developing a data life cycle policy for each data class.

20. A system for developing data life cycle policies as set forth in claim 19, further comprising a transfer agent for facilitating transition of data between components.

21. A system for developing data life cycle policies as set forth in claim 19, wherein said means for generating a state transition diagram for each class generates a state for different stages of data life.

22. A system for developing data life cycle policies as set forth in claim 19, wherein said means for generating a state transition diagram generates a state transition diagram including at least one source state, at least one destination state, and at least one condition for data transition from a source state to a destination state.

23. A system for developing data life cycle policies as set forth in claim 22, further comprising a transfer agent for moving data from a first storage pool to another storage pool.

24. A system for developing data life cycle policies as set forth in claim 22, wherein said means develops a data life cycle policy comprising a component that supports the source state and the destination state.

25. A system for developing data life cycle policies as set forth in claim 22, wherein the data life cycle policy comprises a plurality of components that support the source state and the destination state.

26. A system for developing data life cycle policies as set forth in claim 22, wherein the life cycle policy comprises a plurality of components and a transfer agent for facilitating transition of data between at least some of the plurality of components.

27. A system for developing data life cycle policies as set forth in claim 22, further comprising a transfer agent for facilitating transition of data between components.

28. A system for developing data life cycle policies as set forth in claim 19, wherein traversing the state transition diagram tests whether the data belongs to a predetermined data class, the data is in a source state and a condition for transition to a destination state is met.

29. A system for developing data life cycle policies as set forth in claim 28, wherein the transition from a source state to a destination state includes moving data from a first storage pool to another storage pool.

30. A system for developing data life cycle policies as set forth in claim 28, wherein the transition from a source state to a destination state includes moving data from a storage pool to a backup state.

31. A system for developing data life cycle policies as set forth in claim 19, wherein the predetermined attributes are related to data content.

32. A system for developing data life cycle policies as set forth in claim 19, wherein the predetermined attributes are related to data usage.

33. A system for developing data life cycle policies as set forth in claim 19, wherein the attributes comprise at least some of whole file name, partial file name, file type, file size, file age, application used to create data, identification of owner, identification of group, file set to which file belongs and client name.

34. A signal bearing medium tangibly embodying a program of machine-readable instructions executable by a digital processing apparatus to perform operations to develop a data life cycle policy, the operations comprising:
classifying data according to predetermined attributes;
specifying states in which classified data may reside;
specifying respective components that support different one or more associated states;
generating a state transition diagram for each data class where at least one condition is associated with each transition between states; and
traversing the state transition diagram for developing a data life cycle policy for each data class.

35. A signal bearing medium as set forth in claim 34, where said operation of generating a state transition diagram for each class generates a state for different stages of data life.

36. A signal bearing medium as set forth in claim 34, where the states of the state transition diagram are related to at least one of allocation options, caching options, performance priority and availability rights.

37. A signal bearing medium as set forth in claim 34, where the states comprise a collection of management attributes comprising a name of a storage pool in which the data or file is stored.

38. A signal bearing medium as set forth in claim 34, where the states comprise at least one of online data, offline data, long-term data retention, deleted data, immutable data, backup copy, archive copy, and replicated copy.

39. A signal bearing medium as set forth in claim 34, where the state transition diagram comprises at least one source state, at least one destination state, and at least one condition for data transition from the source state to the destination state.

40. A signal bearing medium as set forth in claim 34, where the algorithm for traversing the state transition diagram tests whether the data belongs to a predetermined data class, the data is in a source state and a condition for transition to a destination state is met, where the transition from the source state to the destination state comprises one of moving data from a storage pool to another storage pool, and moving data from the storage pool to a backup state.

41. A signal bearing medium as set forth in claim 34, where the predetermined attributes are related to at least one of data content and data usage.

42. A signal bearing medium as set forth in claim 34, where the attributes comprise at least one of: whole file name, partial file name, file type, file size, file age, application used to create data, identification of owner, identification of group, file set to which file belongs and client name.
